(19) United States
(12) Patent Application Publication
(10) Pub. No.: US 2016/0091129 A1
(43) Pub. Date: Mar. 31, 2016

(54) EXPANSION JOINT OF UNDERGROUND PIPING HAVING AUTOMATIC LOCKING STOPPER ATTACHED THERETO

(71) Applicant: JOINT YOOCHANG THERMAL SYSTEMS CO., LTD., Gyeonggi-do (KR)

(72) Inventor: Chang Yup AN, Anyang-si (KR)

(21) Appl. No.: 14/890,159

(22) PCT Filed: May 8, 2014
(86) PCT No.: PCT/KR2014/004056

§ 371 Date: Nov. 9, 2015

(30) Foreign Application Priority Data
May 10, 2013 (KR) 10-2013-0052989

(51) Int. Cl. F16L 27/12; F16L 37/084

(52) U.S. Cl. CPC F16L 27/12; F16L 37/0847

(57) ABSTRACT

Disclosed is an expansion joint of underground piping having an automatic locking stopper attached thereto, the expansion joint having at least one stopping groove (22) formed along the outer circumference of a slip pipe (20), and locking grooves (35, 23) formed such that locking members (36, 25) locked by being stopped in the stopping groove (22) are accommodated therein and protrude therefrom on the inner circumference of an entrance side of a stuffing box (30). Thus, the provided expansion joint of underground piping having an automatic locking stopper attached thereto, has an automatic locking stopper for automatically locking a reverse movement due to a temperature change after absorbing an expansion amount up to a calculated expansion amount as a locking member which is formed on the inner circumference of a stuffing box by a stopping groove formed along the outer circumference of a slip pipe, through the expansion joint having the stuffing box in which the slip pipe expands and is transported, thereby guiding a plurality of expansion joints so as to expand and absorb the expansion amount up to a calculated expansion amount of piping and displaying a moving distance thereof.

### TECHNICAL FIELD

The present invention relates to an expansion joint of buried piping having automatic locking stopper, and also relates to a disposable expansion joint of buried piping (as connection means applied to repair the buried piping system, it is an expansion joint structure that can be used only once in the piping system absorbing expansion of the piping system like the existing piping system, by welding and fixing its boundary surface in a situation where a slip pipe flexibly moves to the maximum to an inside diameter of a stuffing box, even though entire piping system expands to a calculated prestress. It is referred as the expansion joint, hereinafter.), particularly, it relates to an expansion joint of buried piping having automatic locking stopper which prevents a reverse movement depending on a temperature change of entire piping system, and also may indicate its expansion absorption movement length, through the expansion joint configured by several stoppers at each of expansion absorption displacements between a slip pipe and a stuffing box.

### BACKGROUND ART

Currently, an embedding method of a heating piping for district heating used in Korea constructs a plurality of fluid transport pipelines without an expansion joint by means of heat expansion constraint method (non-compensated method) and forms a fluid transport conduit. These conduit for fluid transport induces expansion thereof, when hot fluid of about 120° C. such as the fluid for district heating is used for a long period. The expansion of conduit causes crack and damage of laid piping itself, or transported fluid is leaked to underground by even slight ground deformation because the pipelines are abnormally distorted, then the fluid leaked to underground flows out onto road and obstructs road traffic, therefore energy is wasted by discharging the fluid of high temperature.

In a method known to solve the problem, a repairing has been made by excavating all the laid conduits, solving the cause of leakage (by piping replacement etc.), subsequently heating the piping to predetermined calculated preheating temperature by introducing the fluid about 60° C. or using electricity, and then backfilling.

However, the above conventional repair method has following problems.

First, in order to make the repaired pipeline return to its original place, preheating for sufficient time is required to make the piping system back into place, such that there is a cost increase due to preheating itself, and besides, for keeping the entire preheating unit intervals in excavated state until the preheating is completed, there remains risks such as traffic obstruction in downtown as well as falls of pedestrian.

Second, because of this repair work, there is incurred additional cost in accordance with increase of construction period, also the repair work results into cause of civil complaint for traffic interference of downtown area, particularly, digging permission to make this piping repair work on the existing traffic congestion roads in the downtown is approved by the road management office on condition that both digging and backfilling are completed within the very one day or on condition of night time digging and backfilling for reasons such as the traffic congestion and the civil complaint of construction area around, etc., therefore there is a problem that there is not sufficient time to carry out the piping preheating of pipelines in excavated state.

Further, the repair method cannot process quickly the emergent situation of fluid continuously leaked and it has many problems involving much manpower mobilization etc. in accordance with digging the entire buried piping system.

Meanwhile, an expansion joint means of a bellows type has been known in the piping system in the related art.

It is comprised of the structure such as shown in the accompanying drawings FIG. 1a to FIG. 1c. The method is similarly developed and in use in Europe (Denmark, Germany, Sweden, etc.). In the expansion joint means of the bellows type, the flexible bellows is connected between an inner and an outer pipes, and the bellows stretches (with expansion and contraction behavior) when thermal expansion occurs due to transported fluid of piping system, so that it is contracted corresponding to the ground contraction amount. However, since the bellows, major composition of the expansion joint means of the bellows type, is composed of stainless steel and it is different material from piping of carbon steel material, it has the welding brittleness by different materials and also a problem of the fatigue brittleness by continued use of bellows.

To solve the problem, while the entire piping system has a designed pre-stress and behaves as preheated piping in the state where a slip pipe maximally moves to internal diameter of a stuffing box, by introducing the pre-stress by partial interval preheating using heat expansion constraint method (the non-compensated method) which designs and constructs such that the stress by heat occurred in steel pipe is to be within an allowable stress without additional mechanical compensation device (bellows type expansion joint means, etc.), and it is required that more than the expansion amount should be absorbed, because each of expansion joint means should absorb by a pre-calculated expansion amount so as to preheat the long piping at the same time and equally, as in the outside.

### SUMMARY OF THE INVENTION

### Objective of Invention

The purpose of the present invention is to provide an expansion joint having automatic locking stopper, which enables to construct underground buried pipeline in speedy and precise manner so as to repair the piping to fit the designed dimensions in the early stage of construction of the piping system and constructs a plurality of expansion joints and then backfills, and which prior to that, make it possible that each of the expansion joints absorbs the expansion amount by a calculated expansion amount during the preheating air transmission, and the expansion joint is prevented a reverse movement by the calculated expansion amount such that the expansion movement cannot be beyond.

### Measures to Achieve the Objective

An expansion joint of buried piping having automatic locking stopper of the present invention to achieve the above purpose is achieved by expansion joint, wherein

at least one or more stopping groove is formed along an inner and outer circumferences of a slip pipe, and

a locking member and a locking groove are formed which are corresponding to the stopping groove and simultaneously locked in an inner and outer circumference of a stuffing box.

In an expansion joint of buried piping having automatic locking stopper of the present invention to achieve the above purpose, it is advisable that two or more stopping grooves are formed as a first stopping groove, a second stopping groove, and a third stopping groove, etc. at a predetermined distance to measure a deformed expansion length of the expansion joint thereby indicating the displacement.

### Advantageous Effect

As described above, according to the present invention it is possible to repair the piping to fit the designed dimensions in an early stage of construction of the piping system in case that leakage occurs due to bending phenomenon by thermal expansion of a fluid transport piping system and ground subsidence etc., in particular it is possible to provide expansion joint of the underground buried pipeline in the speedy and precise manner, and it is possible to provide stable piping by providing a plurality of expansion joints which automatically lock the reverse movement of the fluid transport inner pipe after absorbing the expansion amount by the calculated expansion amount (depending on the temperature change of the transported fluid).

And also the present invention prevents the reverse movement according to the slip action by piping system expansion due to various temperature drop, ground subsidence, and ground change etc. of the underground, of the buried piping, and the present invention indicates that expanded/contracted amount. Also, when the partial leakage in the slip pipe and the stuffing box occurs, it is repaired by the expansion joint structure of the present invention and while according to the present invention movement by length of expanded/contracted slip pipe is made which is then welded to enable to work according to prestress of the existing piping system.

### BRIEF DESCRIPTION OF THE DRAWINGS

FIGS. 1a, 1b and 1c are enlarged views of main portion of a conventionally known expansion joint of bellows type.

FIG. 2a is enlarged view of main portion of an expansion joint while an expansion joint of buried piping having automatic locking stopper of the present invention is being used during construction of the expansion joint of buried piping having automatic locking stopper, which is before preheating.

FIG. 2b is enlarged view of main portion of an expansion joint while an expansion joint of buried piping having automatic locking stopper of the present invention is being used during construction of the expansion joint of buried piping having automatic locking stopper, which is after preheating.

FIG. 3a is enlarged view of main portion of an expansion joint while an expansion joint of buried piping having automatic locking stopper of another exemplary embodiment of the present invention is being used during construction of the expansion joint of buried piping having automatic locking stopper, which is before preheating.

FIG. 3b is enlarged view of main portion of an expansion joint while an expansion joint of buried piping having automatic locking stopper of another exemplary embodiment of the present invention is being used during construction of the expansion joint of buried piping having automatic locking stopper, which is after preheating.

FIG. 4 shows the state of installing an expansion joint and backfilling only piping system after excavating entire piping system, in construction method of a fluid transport piping using an expansion joint of buried piping having automatic locking stopper of the present invention.

FIG. 5 is a schematic diagram of state wherein backfilling of entire piping system including an expansion joint is made, in construction method of a fluid transport piping using an expansion joint of buried piping having automatic locking stopper of the present invention.

FIG. 6 shows the state that the piping system including an expansion joint prevents slip pipe from reversely moving to locking state in a stuffing box due to thermal expansion during the fluid transport, in construction method of a fluid transport piping using an expansion joint of buried piping having automatic locking stopper of the present invention.

FIG. 7 is shows the state that the piping system including an expansion joint prevents slip pipe from reversely moving to locking state in a stuffing box due to thermal expansion during the fluid transport, in construction method of a fluid transport piping using an expansion joint of buried piping having automatic locking stopper of another exemplary embodiment of the present invention.

### DETAILED DESCRIPTION

Hereinafter, exemplary embodiments of the present invention will be described in detail with reference to the accompanying drawings.

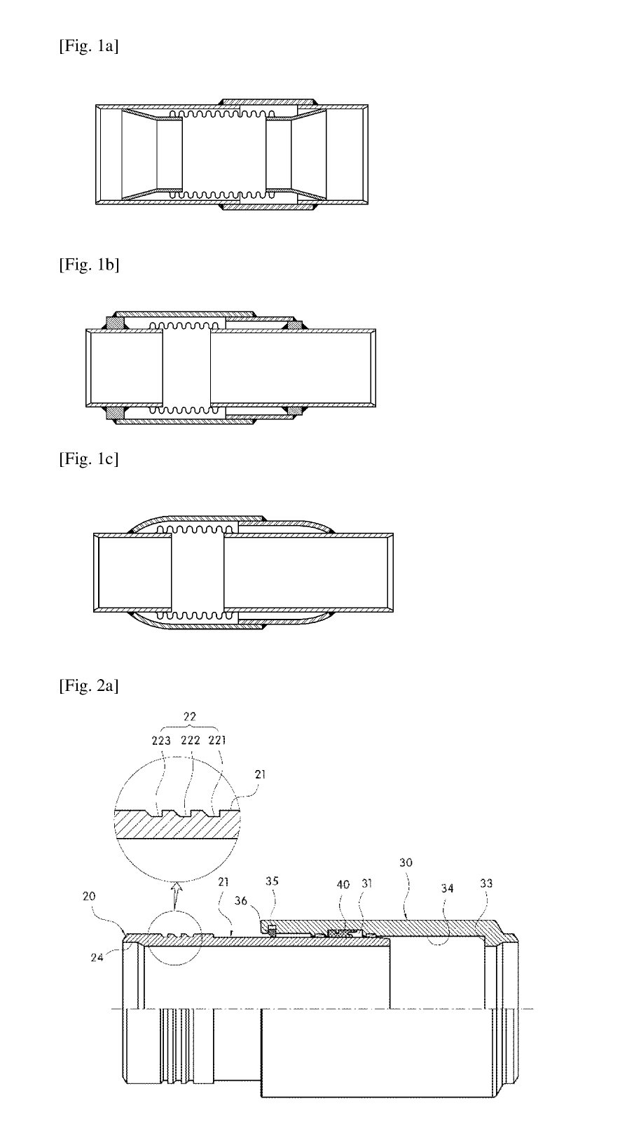

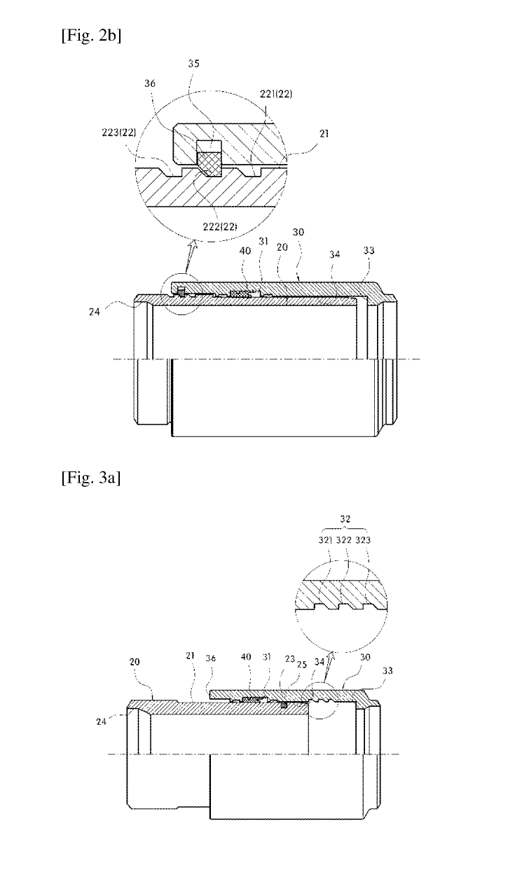

In the accompanying drawings, FIG. 2a is enlarged view of main portion of an expansion joint while an expansion joint of buried piping having automatic locking stopper of the present invention is being used during construction of the expansion joint of buried piping having automatic locking stopper before preheating, and FIG. 2b is enlarged view of main portion of an expansion joint while an expansion joint of buried piping having automatic locking stopper of the present invention is being used during construction of the expansion joint of buried piping having automatic locking stopper after preheating.

An expansion joint of buried piping having automatic locking stopper of the present invention according referring to the above drawings is,

forming at least one or more stopping groove (22) along an outer circumference of a slip pipe (20), and forming a first locking groove (35) such that a first locking member (36) engaged and locked in the stopping groove (22) is accommodated therein and protrude therefrom on an inner circumference of an entrance side of a stuffing box (30). The stopping groove (22) is formed as a first stopping groove (221), a second stopping groove (222), and a third stopping groove (223), etc. at a predetermined distance to measure deformed expansion length of expansion joint as the calculated expansion amount. The length and distance of the stopping grooves are applied to reflect the pre-designed value depending on the construction site conditions.

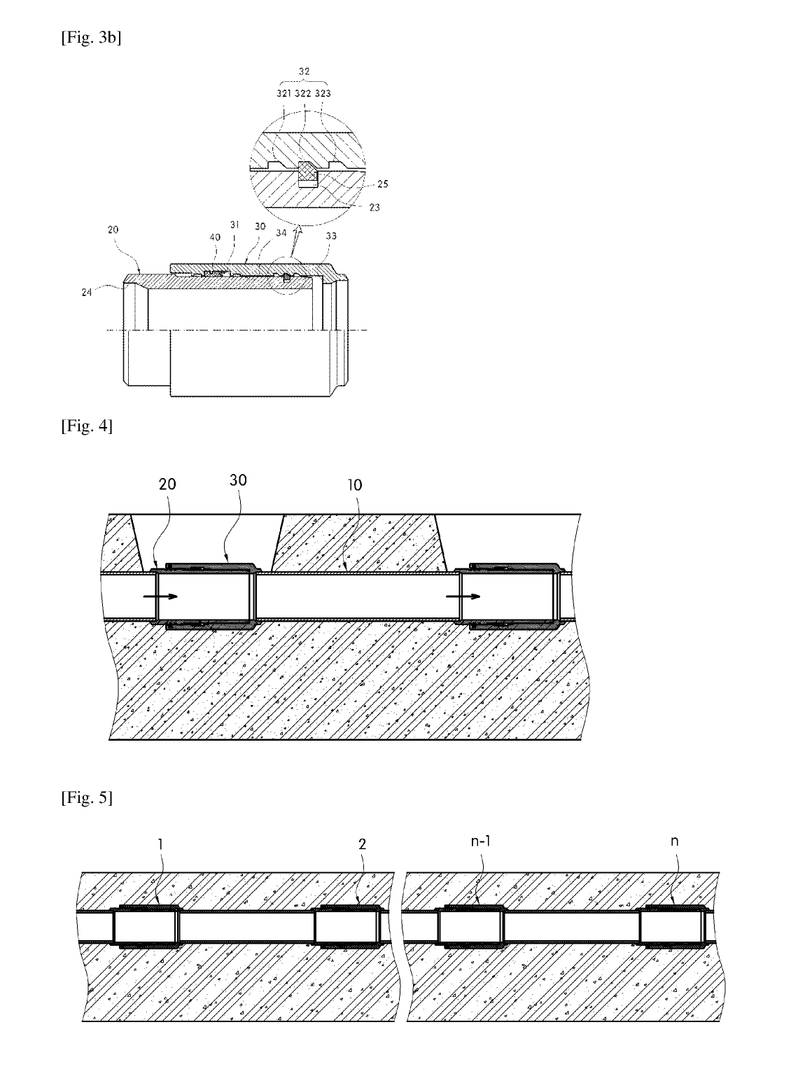

In the accompanying drawings, FIG. 3a is enlarged view of main portion of an expansion joint while an expansion joint of buried piping having automatic locking stopper of another exemplary embodiment of the present invention is being used during construction of the expansion joint of buried piping having automatic locking stopper before preheating, and FIG. 3b is enlarged view of main portion of an expansion joint while an expansion joint of buried piping having automatic locking stopper of another exemplary embodiment of the present invention is being used during construction of the expansion joint of buried piping having automatic locking stopper after preheating.

An expansion joint of another exemplary embodiment of an expansion joint system of buried piping having automatic locking stopper of the present invention according referring to the above drawings is,

forming at least one or more stopping groove (32) along an inner circumference of the stuffing box (30), and forming a second locking groove (23) such that a second locking member (25) engaged and locked in the stopping groove (32) is accommodated therein and protrude therefrom on an outer circumference of an entrance side on front end of the slip pipe (20). A plurality of stopping grooves (32) is numerously formed as a first stopping groove (321), a second stopping groove (322), and a third stopping groove (323), etc. at a predetermined distance to measure deformed expansion length of expansion joint as the calculated expansion amount. The length and distance of the stopping grooves are applied to reflect the pre-designed value depending on the construction site conditions.

A construction method of an expansion joint system of buried piping having automatic locking stopper of the present invention comprises the steps of: installing the expansion joint, preheating the piping system, backfilling, and confirming the reverse movement.

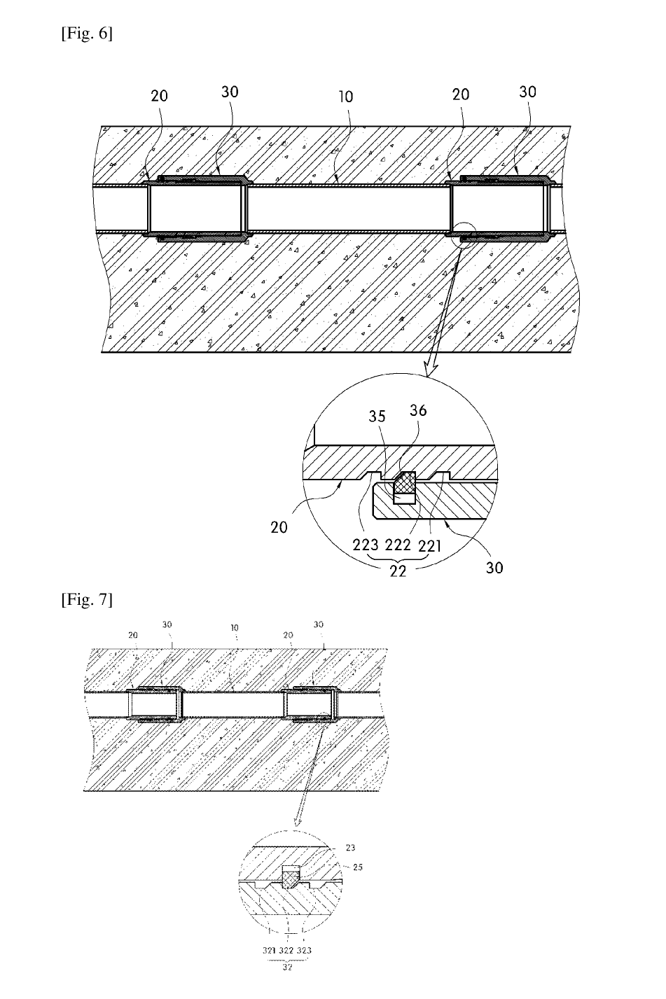

In the accompanying drawings, FIG. 4 is the state of installing an expansion joint and backfilling only piping system after excavating entire piping system, in construction method of a fluid transport piping of downtown underground using an expansion joint of buried piping having automatic locking stopper of the present invention, and FIG. 5 is a schematic diagram of state wherein backfilling of entire piping system including an expansion joint is made, in construction method of a fluid transport piping using an expansion joint of buried piping having automatic locking stopper of the present invention, FIG. 6 is a view indicating the state that the piping system including an expansion joint prevents slip pipe from reversely moving to locking state in a stuffing box due to thermal expansion during the fluid transport, in construction method of a fluid transport piping using an expansion joint of buried piping having automatic locking stopper of the present invention, and FIG. 7 is a view indicating the state that the piping system including an expansion joint prevents slip pipe from reversely moving to locking state in a stuffing box due to thermal expansion during the fluid transport, in construction method of a fluid transport piping using an expansion joint of buried piping having automatic locking stopper of another exemplary embodiment of the present invention.

According to the drawings, the installing the expansion joint step (step a) in the construction method of a fluid transport piping of downtown underground using the expansion joint of the present invention is installing the expansion joints to enable the slip pipes (20) of the expansion joint of buried piping having automatic locking stopper to enter the stuffing box (30) in the state that only an expansion joint installation section is excavated, such as shown in the FIG. 4.

According to the drawing, the preheating the piping system step (step b), in the construction method of a fluid transport piping of downtown underground using an expansion joint of buried piping having automatic locking stopper of the present invention, is preheating the entire piping system to the pre-calculated preheating temperature in the state that the expansion joint is installed, thereby making thermal expansion of the thermal system, so that it makes each of the slip pipes (20) of the expansion joints of the entire piping system closely contact and maintain into the stuffing box (30).

Further, the preheating the piping system step of the present invention is executed based on what is shown on drawings following the below detailed steps.

That is, first, a first expansion joint (1) of a first position comprising a first slip pipe (20) and a first stuffing box (30), and a first piping part comprising the expansion joint (1) and connected thereto are preheated.

Next, an expansion joint (2) of a second position comprising a second slip pipe (20) and a second stuffing box (30), and a second piping part comprising the expansion joint (2) and connected thereto are preheated.

Next, the expansion joint (2) of a third position comprising a third slip pipe (20) and a third stuffing box (30), and a third piping part comprising the expansion joint (2) and connected thereto are preheated.

Next, an expansion joint (n−1) of a (n−1)th position comprising a (n−1)th slip pipe (n−1) and a (n−1)th stuffing box (n−1), and a (n−1)th piping part (n−1) comprising the expansion joint (n−1) and connected thereto are preheated. In the same manner as the above procedure, an expansion joint (n) of a (n)th position comprising a (n)th slip pipe (n) and a (n)th stuffing box (n), and a (n)th piping part (n) comprising the expansion joint (n) and connected thereto are preheated. Thus, by electrical preheating sequentially and continuously from the first expansion joint of a plurality of the expansion joints until the slip pipe of the last expansion joint reaches an inner stopper of its stuffing box, and thereby moving into contracted state sequentially and step by step, the entire piping system from the first piping part (1) to the (n)th piping part (n) is sequentially preheated and contracted.

According to the drawings, the backfilling step (step c), in the construction method of a fluid transport piping of downtown underground using an expansion joint of buried piping having automatic locking stopper of the present invention, is backfilling (landfill) the expansion joint part which is excavated after finishing the preheating the pipeline step, over the entire piping system, such as shown in the FIG. 5.

According to the drawings, the confirming the reverse movement step (step d), in the construction method of a fluid transport piping of downtown underground using an expansion joint of buried piping having automatic locking stopper of the present invention, is a step which confirms the movement length after a given period, of the buried piping system with the naked eye, and confirms the reverse movement length of the stuffing box through the first stopping groove (221), the second stopping groove (222), and the third stopping groove (223) formed step by step on the slip pipe (20), thereby confirming the reverse movement length of buried state of the piping system.

As shown in the FIG. 6, in case that the reverse movement of the slip pipe (reverse slip) occurs due to sudden temperature drop and ground change inflicted on the piping system in the buried state, the slip pipe moves backward (reverse movement), and the reverse movement is stopped by protruding of the first locking member (36) on the stopping groove (22) formed in the slip pipe (20) of the expansion joint of the present invention.

That is, as shown in the FIG. 6, it is possible to confirm the backward deformed length of the expansion joint, i.e. its amount of displacement after excavating with the naked eye, because the first stopping groove (221), the second stopping groove (222), and the third stopping groove (223) etc. are formed at the predetermined segmented distance. That is, the situation shown in the FIG. 6 can confirm the amount of displacement, because it is stopped on the second stopping groove (222).

Meanwhile, in the confirming the reverse movement step (step d), in the construction method of a fluid transport piping of downtown underground using an expansion joint of buried piping having automatic locking stopper of the present invention, the slip pipe (20) is entered along an inner circumference of the stuffing box (30) and the second locking member (25) operates the locking on the stopping groove (32), as in accompanying drawing, FIG. 7. The operation is moved as the expansion length by the first stopping groove (321), the second stopping groove (322), and the third stopping groove (323), and a moving distance thereof is confirmed through a side of slide (21) of the slip pipe (20) (displaying the scale).

An expansion joint of buried piping having automatic locking stopper of the present invention and a construction method of the expansion joint of buried piping having automatic locking stopper using the same which are comprised in this manner includes a stopping device automatically implementing locking to prevent a reverse movement in case that the reverse movement occurs depending on the temperature change after absorbing the expansion by the calculated expansion amount, therefore they can prevent the reverse movement of the slip pipe (reverse slip) occurring due to sudden temperature drop and ground change inflicted on the piping system in the buried state and a plurality of expansion joints can maintain the expansion amount absorbed by the calculated expansion amount.

Therefore, backward movement is made depending on the expansion of the pipeline that the piping in the buried state received in stopping grooves formed step by step on the expansion joint, so that it is possible promptly responding to natural expansion and contraction of the underground buried piping, and also it enables to confirm a level of the expansion and contraction by excavating the expansion joint part, which makes it possible having more precise data on the operation and maintenance of the buried piping.

DESCRIPTION OF SYMBOLS

| | |
|---|---|
| 1, 2, 3 . . . n − 1, n: expansion joint | 10: piping |
| 20: slip pipe | 30: stuffing box |
| 40: main packing | 21: outside of slide |
| 22, 23: stopping groove | 221, 321: first stopping groove |
| 222, 322: second stopping groove | 223, 323: third stopping groove |
| 23: second locking groove | 23: connecting part |
| 25: second locking member | 31: packing engaging groove |
| 33: stopper | 34: inside of slide |
| 35: first locking groove | 36: first locking member |
| 42: secondary packing | |

What is claimed is:

1. An expansion joint of buried piping having automatic locking stopper, wherein
a first stopping groove (221), a second stopping groove (222), and a third stopping groove (223) are formed at a predetermined distance along an outer circumference of a slip pipe (20),
a first locking member (36) which is engaged and locked in the first stopping groove (221), the second stopping groove (222), and the third stopping groove (223) is formed on an inner circumference of an entrance side of a stuffing box (30), and
wherein said first locking member (36) is protrudably accommodated in the first locking groove (35) and measures a deformed length by locking during expansion deformation of the slip pipe (20).

2. An expansion joint of buried piping having automatic locking stopper according to claim 1, wherein a first stopping groove (321), a second stopping groove (322), and a third stopping groove (323) are formed along an inner circumference of the stuffing box (30), and a second locking member (25) which is engaged and locked in the first stopping groove (321), the second stopping groove (322), and the third stopping groove (323) is protrudably accommodated in a second locking groove (23) on an outer circumference of the slip pipe (20).
